(19) United States
(12) Patent Application Publication
(10) Pub. No.: US 2011/0006461 A1
(43) Pub. Date: Jan. 13, 2011

(54) SYSTEM AND METHOD FOR MEASURING CERAMIC-FORMING BATCH MOISTURE CONTENT

(76) Inventors: David Dasher, Corning, NY (US); Robert John Locker, Corning, NY (US); James Monroe Marlowe, JR., Horseheads, NY (US)

Correspondence Address: CORNING INCORPORATED, SP-TI-3-1, CORNING, NY, 14831, US

(21) Appl. No.: 12/919,341

(22) PCT Filed: Feb. 25, 2009
(86) PCT No.: PCT/US09/01180

§ 371 Date: Aug. 25, 2010

Related U.S. Application Data
(60) Provisional application No. 61/067,613, filed on Feb. 29, 2008.

(51) Int. Cl. B29C 47/92; B29C 47/00; G01B 11/00; B29C 47/08

(52) U.S. Cl. 264/408; 264/40.1; 425/169

(57) ABSTRACT

A system and method is disclosed for measuring in real-time the moisture content of a ceramic-forming batch material to be extruded to form a ceramic article. The system includes a moisture-content-measurement (MCM) system that measures optical absorbance. Material-specific batch calibration samples can be used to calibrate optical absorption measurements to accurate moisture-content measurements. Because the surface of the batch material tends to dry during the extrusion process, a batch-material-removal (BMR) device is used to remove or displace batch surface material so that the moisture content of the underlying batch material can be measured.

### RELATED APPLICATIONS

This application claims the benefit of U.S. Provisional Application No. 61/067,613, filed Feb. 29, 2008, entitled “System and Method for Measuring Ceramic-Forming Batch Moisture Content.”

### FIELD

The present invention relates to the extrusion of ceramic-forming materials, and in particular relates to system and methods for measuring the moisture content of ceramic- forming batch materials.

### BACKGROUND

Extrusion processes are used in a variety of industries to form a wide range of products. One type of extrusion process uses a ceramic-forming material that forms an extrudate from a plasticized mixture that is extruded through a die orifice. Ceramic honeycomb-shaped articles having a multitude of cells or passages separated by thin walls running parallel to the longitudinal axis of the structure have been formed via extrusion. A number of parameters need to be controlled in the extrusion process in order for the desired article to maintain its post-extrusion form and to ultimately form an article that meets its particular design and/or performance requirements. Such parameters include, for example, the particular composition of the mix that makes up the batch. The amount of water (moisture) present in the batch is another key parameter that needs to be carefully controlled. A batch having insufficient moisture will not extrude properly and could lead to the formation of cracks in the final article. On the other hand, a batch having too much moisture will not extrude properly and could lead to deformation of the extrudate or extruded article.

### SUMMARY

One aspect of the present invention is a method of extruding ceramic-forming batch material. The method includes conveying the ceramic-forming batch material, and exposing an underlying portion of the batch material. The method further includes measuring a moisture content of the underlying portion of the conveyed batch material while the batch material is being conveyed, and extruding the conveyed batch material. The moisture content is measured in real-time.

Another aspect of the invention is a system for extruding ceramic-forming batch material. The system includes an extruder, and a conveyor for conveying the batch material towards the extruder. A batch-material-removal device is disposed proximate the conveyor and upstream of the extruder. The device is positioned to remove or move aside a layer of the batch material as the batch material is conveyed past the device so as to expose an underlying portion of the batch material. The system also includes a moisture content sensor device positioned in proximity to the conveyor sufficient to allow moisture content sensing of the underlying portion of the batch material. An example batch-material-removal device is a plow mechanism that is inserted into the batch material to an adjustable depth to displace a select amount of batch material.

These and other advantages of the invention will be further understood and appreciated by those skilled in the art by reference to the following written specification, claims and appended drawings.

### BRIEF DESCRIPTION OF THE DRAWINGS

FIG. 1 is a schematic diagram of an extrusion system as disclosed herein that includes a real-time moisture-content-measurement (MCM) system;

FIG. 2 is a perspective view of an example honeycomb body formed by extrusion using the extrusion system of FIG. 1;

FIG. 3A is a close up view of a portion of the conveyor unit of the extrusion system of FIG. 1, showing a batch-material-removal (BMR) device in the form of a plow apparatus, and also showing an optical sensor head arranged adjacent to and immediately downstream of the plow apparatus;

FIG. 3B is a plan view of the portion of the conveyor unit as shown in FIG. 3A, showing the wedge-shaped plow member and the field of view of the optical sensor head that measures the moisture content of the batch material behind the plow member;

FIGS. 4A plots the calibration data as raw measurements of “% water” as taken by the moisture-content-measurement (MCM) system versus the calibration sample “% water,” and plots the regression fit to the calibration data;

FIG. 4B plots the “moisture (% dry) versus the calibration samples for the actual calibration data versus the measured moisture content values from the calibrated MCM system;

FIG. 5A is similar to FIG. 3A and illustrates an example embodiment of an extrusion system as disclosed herein that includes a temperature sensor configured to measure the temperature of the batch material; and

FIG. 5B is similar to FIG. 3B and illustrates an example placement of the temperature sensor field of view relative to the optical sensor head field of view.

### DETAILED DESCRIPTION

Reference is now made in detail to the present preferred embodiments of the invention, examples of which are illustrated in the accompanying drawings. Whenever possible, the same reference numbers and symbols are used throughout the drawings to refer to the same or like parts.

The present invention is concerned with the extrusion of a plasticized ceramic- forming mixture into articles of widely differing profiles and shapes such as honeycomb structures. For example, thin-walled honeycomb structures can be formed by extruding ceramic-forming mixtures which flow or are plastically deformed under pressure during extrusion, but which have the ability to maintain their as-extruded form under ambient conditions after being relieved of the high extrusion shear forces. An apparatus and methods are disclosed herein for measuring, in real time, the moisture content of the batch material prior to the batch material being extruded so that the actual moisture content can be determined and, if necessary, be adjusted, such as by a system operator.

An “inorganic batch” includes a mixture of inorganic constituents; a batch may also contain pore-forming constituents, such as graphite or organic material such as methylcellulose, which may make up a minor portion (e.g., about 1% to about 7%) of the mixture.

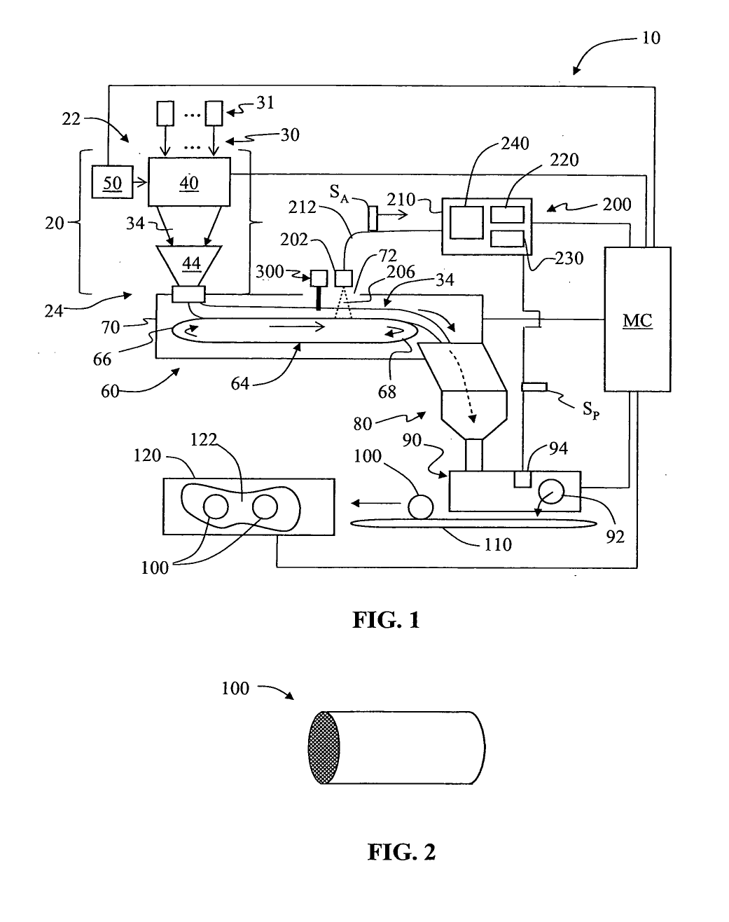

FIG. 1 is a schematic diagram of an example embodiment of an extrusion system 10 used to form ceramic-based articles from a ceramic-forming material or mixture . Extrusion system 10 includes a mixing stage or “wet tower” 20 having an input end 22 and an output end 24. Wet tower 20 receives at an input end 22 various batch material constituents 30 in dry form from respective constituent sources 31, and mixes them along with water (and optionally oil) to form an initial ceramic-forming batch mixture. Wet tower 20 includes, for example, a mixer 40 followed by a rotary cone 44. Wet tower 20 also includes a water unit 50 configured to provide water to mixer 40 in select amounts, e.g., by weighing the amount of water added to the mixer. In an example embodiment, water unit 50 is controlled manually and/or automatically, as discussed below.

Extrusion system 10 further includes a conveyer unit 60 shown arranged adjacent output end 24 of wet tower 20. Conveyor unit 60 includes a conveyor belt 64 with an input end 66 and an output end 68. Preferably conveyor unit 60 is a Thayer belt unit. Conveyor belt can rotate clockwise as shown. Conveyor unit 60 includes a protective cover 70 that has, near conveyor belt output end 68, an aperture 72. In an example embodiment, conveyor belt 64 is between about 1.2 and 1.5 meters (about 4 and 5 feet long).

Conveyor belt input end 66 is arranged at the output end 24 of wet tower 20 so as to receive batch material 34 therefrom. In an example embodiment, rotary cone 44 serves to deliver batch material 34 to conveyor belt input end 66 in a relatively uniform layer. In an example embodiment, material 34 is carried by conveyor belt 64 in a layer having a thickness between about 2.5 cm and 5.0 cm (about one inch and two inches) and a width between about 25 cm and 36 cm (about ten inches and fourteen inches). In some embodiments, wet tower 20 is configured to adjust the thickness of the layer of batch material 34 carried by conveyor belt 64.

Extrusion system 10 further includes a chute 80 and an extrusion unit 90. Chute 80 is arranged between conveyor unit 60 and extrusion unit 90. Chute 80 is configured to receive batch material 34 from the output end 68 of conveyor belt 64 and deliver it to extrusion unit 90. Extrusion unit 90 is configured to receive batch material 34 and form billets therefrom, which are then pressed through an extrusion die 92 (e.g., by a twin screw extruder) to form extrudate 100. In an example embodiment, extrudate 100 is then cut into sections to further define an extruded piece. An example extrudate 100 has a honeycomb structure, such as shown in FIG. 2 which can be used to form a flow-through substrate or a (plugged) wall flow filter and forms a ceramic filter product 102.

In an example embodiment, extrusion system 10 includes a pressure sensor 94 in extrusion unit 90 electrically connected to controller 210 and configured to measure the pressure in the extrusion unit 90 during extrusion. Pressure sensor generates an electrical signal Sp that is sent to and received by controller 210, which processes and preferably displays the pressure measurements on display 240.

Extrudate 100 is deposited onto a conveyor 110 arranged adjacent extrusion die 92. Extrudate 100 is then cut into pieces which are conveyed by conveyor 110 to a drying station (e.g., an oven) 120. Drying station 120 has an interior 122 where the extrudate pieces 100 reside while drying. In an example embodiment, extrusion unit 90 includes multiple extrusion dies that operate at once to form multiple extrudates 100 at the same time.

With continuing reference to FIG. 1, extrusion system 10 further includes a moisture- content-measurement (MCM) system 200 that includes optical sensor head 202 arranged in or adjacent to aperture 72 in conveyor unit cover 70. Optical sensor head 202 has a field of view 206 directed to batch material 34 passing underneath on conveyer belt 64. A suitable optical sensor head 202 is available from Process Sensors, Corp., Milford, MA. Optical sensor head 202 is adapted to generate an electrical signal S_{A} corresponding to the measured optical absorbance as measured over its field of view 206.

Moisture measurement system 200 further includes a control unit 210 connected to optical sensor head 202 by a wire 212 that carries signal S_{A}. Control unit 210 includes a processor 220 and a computer-readable medium 230. In an example embodiment, control unit 210 is or includes a computer. Control unit 210 also preferably includes a display unit 240.

Optical sensor head 202 is preferably configured to transmit optical radiation at a wavelength between about 1800 nm and 2100 nm, and more preferably between about 1850 and 1950 nm, to detect an amount of absorbance of the optical radiation by batch material 34; in one embodiment, the wavelength is about 1900 nm. These wavelengths are in the near infrared (“NIR”) wavelength range where water has a strong absorbance. Thus, some embodiments of the optical sensor head 202 can also be referred to as a “NIR moisture sensor.” In an example embodiment, optical sensor head 202 includes filters (not shown) that block wavelengths of light other than a selected wavelength such as one or more of the above-mentioned wavelengths. Signal S_{A} generated by optical sensor head 202 thus can represent a raw or uncalibrated measurement of the moisture content of batch material 34.

In an example embodiment, extrusion system 10 includes a master controller MC that is operably connected to wet tower 20 (an in particular to water unit 50 therein), to conveyor unit 70, to extruder 90, and to controller 210 and is configured to control the operation of these system components so as to control the overall operation of the extruder system.

Forming a filter body

In one example embodiment, extrusion system 10 is used to form the ceramic-based honeycombed structures as described above by extruding a wet, preferably aqueous-based ceramic precursor batch through extrusion die 92 to form a wet log having a honeycomb structure. The wet log is cut into a plurality of segmented portions or pieces, and the segmented portions are dried to form a green honeycomb form (also called a “green honeycomb log”). The aqueous-based ceramic precursor mixture preferably comprises a batch mixture of ceramic-(such as cordierite) forming inorganic precursor materials, an optional pore former such as graphite or starch, a binder, a lubricant, and a liquid vehicle. The inorganic batch components can be a combination of inorganic components (including one or more ceramics) which can, upon firing, provide a porous ceramic body. The body preferably has a primary solid phase composition (such as a primary phase composition of cordierite or aluminum titanate).

In some embodiments, the inorganic batch components comprise an alumina source and a silica source. In an example embodiment, the inorganic batch components can be selected from a magnesium oxide source, an alumina-forming source, and a silica source; the batch components can yield a ceramic article comprising predominantly cordierite, or a mixture of cordierite, mullite and/or spinel upon firing. For example, the inorganic batch components can be selected to provide a ceramic article that comprises at least about 90% by weight cordierite, or more preferably 93% by weight cordierite. In an example embodiment, the cordierite-containing honeycomb article consists essentially of, as characterized in an oxide weight percent basis, from about 49 to about 53 percent by weight SiO₂, from about 33 to about 38 percent by weight Al₂O₃, and from about 12 to about 16 percent by weight MgO. To this end, an exemplary inorganic cordierite precursor powder batch composition can comprise about 33 to about 41 weight percent of an aluminum oxide source, about 46 to about 53 weight percent of a silica source, and about 11 to about 17 weight percent of a magnesium oxide source. Exemplary non-limiting inorganic batch component mixtures suitable for forming cordierite are disclosed in U.S. Pat. No. 3,885,977; 5,258,150; U.S. Pubs.

No. 2004/0261384 and 2004/0029707; and RE 38,888, which are all incorporated by reference herein.

The inorganic ceramic batch components can include synthetically produced materials such as oxides, hydroxides, and the like. Alternatively, they can be naturally occurring minerals such as clays, talcs, or any combination thereof, which are selected depending on the properties desired in the final ceramic body.

The green honeycomb log can further be cut into green honeycomb waves of a desired length, and honeycomb waves as formed during the cutting step. The waves can then be heated or fired into a ceramic article. Optionally, the waves or article can be plugged to form a wall flow filter.

Batch moisture measurement

When batch material makes its way from wet tower 20 down conveyer belt 64 and to extruder 90, the upper surface of batch material 34 can start to dry out relative to the material below the upper surface. A moisture measurement made on upper surface batch material will not accurately reflect the true moisture content of the batch material 34 being conveyed past the moisture measurement point. Although the water in the wet tower is preferably weighed in water unit 50 before being added to the batch material in mixer 40, varying amounts of moisture in the so-called ‘dry’ incoming batch material components can occur, e.g. due to environmental changes to which various batch components are exposed, or e.g. because of variability in the process or the batch material itself.

Accordingly, extrusion system 10 further includes a batch-material-removal (BMR) device 300 that facilitates a proper measurement of moisture content in the batch material prior to the batch material being extruded. BMR device 300 is configured to remove or otherwise displace at least a portion of the top layer of batch material 34 of a stream of batch material being conveyed. BMR device 300 resides adjacent to and upstream of optical sensor head 200 so that the optical head sensor field of view 206 measures the underlying batch material after, and preferably immediately after, this material is exposed by the BMR device.

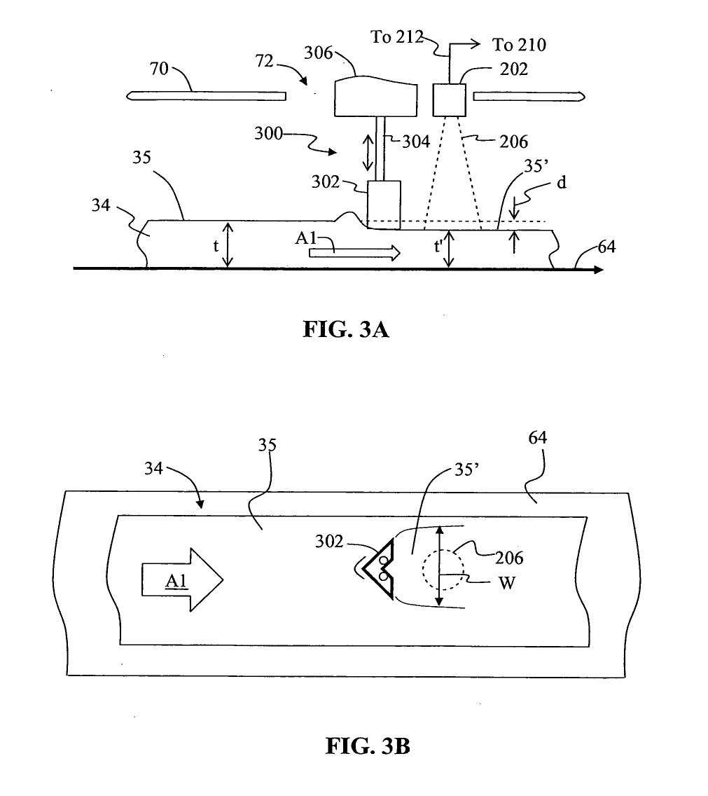

FIG. 3A is a close-up side view of a portion of extrusion system 10 showing the optical sensor head and an example embodiment of BMR device 300 in the form of a plow apparatus arranged relative to the layer of batch material 34, which is conveyed in a layer in the direction of arrow Al. The plow apparatus is preferably adjustable batch material 34 includes an initial top surface 35 and an initial thickness t when the batch material is first conveyed on conveyer belt 64 upstream of BMR device 300, e.g. at input end 66.

Plow apparatus or BMR device 300 includes a plow member 302 connected by one or more support members 304 to a support plenum 306. FIG. 3B is a plan view of the close-up of FIG. 3A, and shows an example embodiment of a wedge-shaped plow member 302. In an example embodiment, plow member 302 is made of stainless steel. The one or more support members 304 are preferably vertically movable to adjust the position, and in particular the vertical position, of plow member 302, relative to conveyor belt 64.

During the extrusion process, plow member 302 is inserted into batch material 34 to a depth d from top surface 35 as the batch material moves along conveyor belt 64. In an example embodiment, depth d is preferably between about 0.5 and 5 mm, and more preferably between about 1 mm and about 3 mm. Plow member 302 removes or displaces (e.g., moves aside) material from initial top surface 35, thereby exposing the underlying batch material 34 and forming a new top surface 35′ and a new thickness t′ (where t′ =t-d), which in some embodiments is only slightly less than the original thickness t. The newly exposed batch material 34 preferably immediately falls within the optical sensor head field of view 206, which is preferably directly behind plow member 302. Because the batch material 34 behind plow member 302 is newly exposed, the moisture content is not appreciably affected by drying (e.g., evaporation) by the local environment and thus provides a more accurate measurement of the moisture content of batch material 34 prior to being extruded. Field of view 206 has a spot size of, for example, about 10 cm (about 4 inches) in width (diameter), so that in an example embodiment the width W of the portion of batch material 34 removed or displaced from batch upper surface 35 is at least as great as the width of the field of view, e.g., 10 cm (4 inches) or greater. In some embodiments, no removed or displaced surface batch material is allowed to enter (or re-enter) the field of view 206.

In other example embodiments, BMR device 300 is or includes a vacuum system (not shown) that displaces the batch material 34 or removes it from the layer, or a shovel-type member (not shown) that displaces the batch material or removes it from the layer.

Calibrating the moisture content measurements

As discussed above, initial measurements taken by MCM system 200 are relative measurements of optical absorbance and so can be treated as raw or uncalibrated measurements of moisture content that need to be calibrated in order to provide an absolute or calibrated moisture content measurement. Accordingly, an aspect of the method of the present invention includes establishing batch calibration samples that have the same material composition as the batch material to be extruded. These composition-specific calibration samples each have a select moisture content, typically provided by weighing exact amounts of water.

In an example embodiment, the water content of batch 34 is measured as “% H₂O minus percent dry weight without organics” or “% dry” for short. In this type of measurement, an amount of water (say X by weight) is added to an amount of dry batch material (say Y by weight) prior to any organics being added to the batch. The water is then added to the dry batch, giving a “% dry” of {[X/Y] x 100}%. The organics, if any are required, are then added to the batch.

The optical absorbance of each calibration sample is measured and the values (“calibration values”) recorded and stored in controller 210, e.g., in computer-readable medium 230. In an example embodiment, the calibration values are used to establish a look- up table, spreadsheet, or like arrangement of moisture content versus absorbance values.

In another example embodiment, the calibration values are fitted to a calibration curve that is then used as a calibration curve for translating raw moisture-content values to calibrated moisture-content values via processor 220. In an example embodiment, the calibrated moisture-content values and/or the calibration curve are displayed on display 240 for the benefit of the system users.

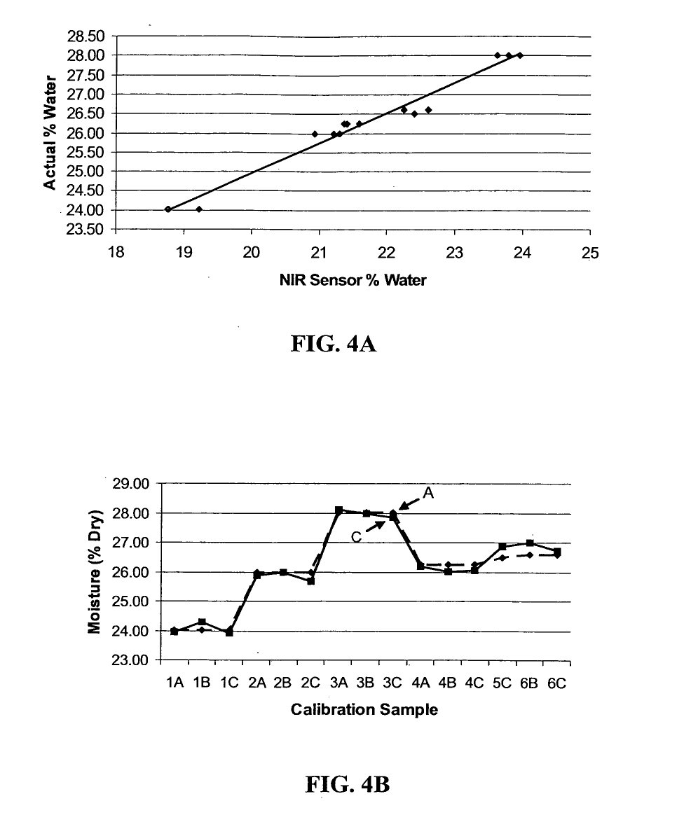

FIG. 4A shows a regression fit of the MCM system (“NIR sensor”) raw moisture content measurement data to the actual amount of water (in % dry) added to the calibration samples. Once the data is fitted to an appropriate line, the slope and offset of this line are used (e.g., in processor 220 and computer-readable medium 230) to calculate the MCM system zero and offset for a particular batch composition. The calibrated system data is then plotted against the actual data to show any potential error in the MCM system after calibration. This plot is shown in FIG. 4B, which shows very good agreement between the actual (A) and measured (C) moisture content (% dry) of the calibrated samples.

Batch material 34 can either continue to be extruded at extruder 90, with the extrudate having a known and acceptable moisture content, or the extrusion process can be terminated if the moisture content is or falls below a threshold value or moisture set point for the particular extruded article being made. In an example embodiment, the calibrated moisture content measurement is used to define a moisture set point for the extrusion system. The moisture set point can be set, for example, in main controller MC, and serve to determine how much water is added to the batch at wet tower 20 via water unit 50.

Adjusting the moisture content

Once the moisture content of batch material 34 is known via a calibrated moisture- content measurement value, this value can serve as the basis for adjusting the batch moisture content. In an example embodiment, the batch material moisture content is adjusted upstream of the position where the moisture measurement is made, e.g., in wet tower 20. The adjustment causes the moisture content to be closer to or equal to a selected moisture content based on the calibrated moisture content measurements. In an example embodiment, the calibrated moisture-content value is provided to main controller MC, which adjusts the amount of water added to the batch via water unit 50 in wet tower 20. In an example embodiment, the process of making a calibrated moisture-content measurement and adjusting the amount of water added to batch material 34 based on the calibrated measurement serves as a feedback system that is used to stabilize the extrusion process. In an example embodiment, feedback involves making repeated measurements of the batch moisture content as the batch material 34 is conveyed to extruder 90 so as to provide frequent (e.g., minute- by-minute) calibrated moisture content measurements of the moving batch material.

Batch temperature measurement

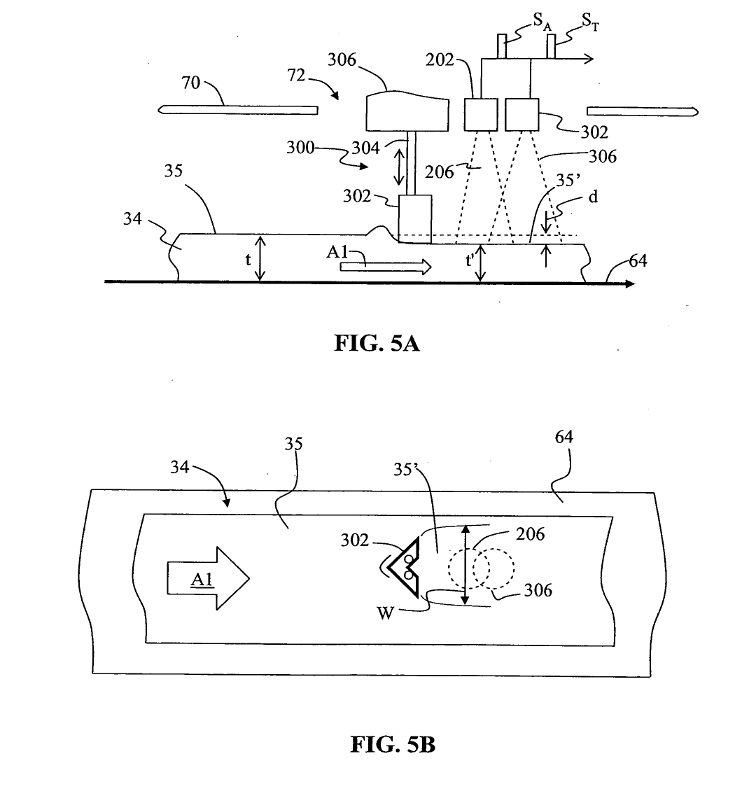

FIG. 5A is similar to FIG. 3A and illustrates an example embodiment of the extrusion system of the present invention that includes a temperature sensor 302 configured to measure the temperature of batch material 34. In an example embodiment, temperature sensor 302 is a non-contact (e.g., an infrared sensor) having a field of view 306. In an example embodiment, temperature sensor 306 is arranged adjacent optical sensor head 202 so that it measures the temperature of the newly exposed batch material 34 at surface 35′. Temperature sensor 302 generates a temperature signal S_{T} that is sent to and received by controller 210, which processes and preferably displays the temperature measurement results on display 240. In an example embodiment, the temperature measurements are used to control the batch temperature during the extrusion process.

FIG. 5B is similar to FIG. 3B and illustrates an example placement of temperature sensor field of view 306 relative to the optical sensor head field of view. This placement allows for measuring the newly exposed batch material 34.

It will be apparent to those skilled in the art that various modifications to the preferred embodiment of the invention as described herein can be made without departing from the spirit or scope of the invention as defined in the appended claims. Thus, it is intended that the present invention covers the modifications and variations of this invention provided they come within the scope of the appended claims and the equivalents thereto.

What is claimed is:

1. A method of extruding ceramic-forming batch material, comprising:
conveying the ceramic-forming batch material;
measuring in real-time a moisture content of the underlying portion of the conveyed batch material while the batch material is being conveyed; and
extruding the conveyed batch material.

2. The method of claim 1 further comprising exposing an underlying portion of the batch material, wherein the moisture content of the underlying portion is measured in real-time.

3. The method of claim 1, wherein the batch material is extruded into a honeycomb- structured extrudate.

4. The method of claim 1, wherein the batch material is substantially comprised of inorganic materials.

5. The method of claim 4, wherein the batch material further comprises an organic material.

6. The method of claim 1, wherein the conveyed batch material has an upper surface, and wherein said exposing further comprises moving aside at least a portion of the conveyed batch material from the upper surface while the batch material is being conveyed.

7. The method of claim 6, wherein the moving aside further comprises plowing into the upper surface.

8. The method of claim 7, further comprising inserting a plow member into the upper surface.

9. The method of claim 1, wherein the layer of the conveyed batch material is disposed on an upper surface of the conveyed batch material prior to being moved aside.

10. The method of claim 1, wherein the thickness of the layer of the conveyed batch material is adjustable.

11. The method of claim 1, wherein the measuring of the moisture content further comprises measuring an optical absorbance of the exposed underlying portion of the batch material.

12. The method of claim 11, wherein the optical absorbance is measured at a wavelength between about 1800 and 2100 nm.

13. The method of claim 11, wherein the optical absorbance is measured with an optical sensor having a field of view, and wherein the exposed underlying portion of the batch material has a width at least as large as a width of the field of view.

14. The method of claim 13, wherein no portion of the moved layer of the conveyed batch material enters the field of view.

15. The method of claim 11, further comprising comparing the measured optical absorbance to a plurality of previously measured optical absorbance values made on a plurality of calibration samples of batch materials having known moisture contents so as to establish a calibrated moisture content measurement.

16. The method of claim 1, wherein the ceramic-forming batch material is conveyed from a batch material source, and wherein the method further comprises adjusting the moisture content of the batch material source in response to the measuring of the moisture content of the underlying portion of the conveyed batch material while the batch material is being conveyed.

17. A system for extruding ceramic-forming batch material, the system comprising:
an extruder;
a conveyor for conveying the batch material towards the extruder; a batch-material-removal device disposed proximate the conveyor and upstream of the extruder, the device positioned and configured to remove or displace a layer of the batch material as the batch material is conveyed past the device so as to expose an underlying portion of the batch material; and
a moisture content sensor device positioned in proximity to the conveyor and to the batch-material-removal device sufficient to allow moisture content sensing of the underlying portion of the batch material.

18. The system according to claim 17, wherein the batch-material-removal device includes a plow configured to move aside a layer of the batch material.

19. The system of claim 17, wherein the moisture content sensor device comprises an optical sensor device configured to measure an optical absorbance of the underlying portion of the batch material.

20. A method of extruding ceramic-forming batch material, comprising:
conveying the ceramic-forming batch material;
exposing an underlying portion of the batch material;
measuring in real-time a moisture content of the underlying portion of the conveyed batch material while the batch material is being conveyed; and
extruding the conveyed batch material.
